(19) United States
(12) Patent Application Publication
(10) Pub. No.: US 2009/0044343 A1
(43) Pub. Date: Feb. 19, 2009

(54) MULTI-USE HAND TOOL

(76) Inventor: Wendy Nicole Grave, Cooper City, FL (US)

Correspondence Address: MAYBACK & HOFFMAN, P.A., 5722 S. FLAMINGO ROAD #232, FORT LAUDERDALE, FL, 33330, US

(21) Appl. No.: 12/189,981

(22) Filed: Aug. 12, 2008

Related U.S. Application Data
(60) Provisional application No. 60/964,432, filed on Aug. 13, 2007.

(51) Int. Cl. B25B 7/22; B23D 21/06

(52) U.S. Cl. 7/126; 30/95; 7/129

(57) ABSTRACT

A pipe-cutting tool includes first and second scissor members pivotally connected to one another where the first scissor member has both a first distal cutting portion with a distal polyvinyl-chloride-pipe cutting blade shaped and of a material for cutting a polyvinyl-chloride pipe and a first proximal grasping portion that has a first outer side shaped to support at least one finger of a user's hand a second inner side having an intermediate portion with a first concave gripping surface having gripping protrusions. The second scissor member has both a second distal cutting portion with a distal concave surface opposing the cutting blade and shaped to support a PVC-pipe therein between ½ inch and 2 inches in diameter and a second proximal grasping portion that has a first outer side shaped to support a palm of a user's hand and a second inner side having an intermediate portion with a second concave gripping surface having gripping protrusions, the second concave gripping surface disposed directly opposite the first concave gripping surface and, together, operable to securely grip a lid therebetween when the first and second proximal grasping portions are moved towards one another.

### CROSS-REFERENCE TO RELATED APPLICATION

This application claims the priority, under 35 U.S.C. §119, of U.S. Provisional Patent Application No. 60/964,432, filed Aug. 13, 2007, the entire disclosure of which is hereby incorporated herein by reference in its entirety.

### FIELD OF THE INVENTION

The present invention relates generally to hand tools, and more particularly relates to a multi-purpose hand tool useful for cutting synthetic piping, removing caps from containers, and extracting sprinkler components.

### BACKGROUND OF THE INVENTION

Polyvinyl chloride, commonly abbreviated “PVC,” is a widely used thermoplastic polymer. In terms of revenue generated, it is one of the most valuable products of the chemical industry. As a construction material, PVC is cheap, durable, and easy to assemble. In recent years, many traditional construction materials, such as steel pipes, have been replaced with PVC material.

Sprinkler systems use pipelines and water-emitting sprinkler heads to deliver water from a water source to a remote target, such as grass, plants, and sometimes people. These sprinkler systems can be subterranean or supraterranean and are well-known in the art. The pipelines connecting the water source to one or more water emitting locations is usually made of a durable PVC material. This material is commonly cut to a desired length by using a PVC cutting tool, such as the tool 100 shown in FIG. 1. This particular type of PVC cutting tool 100 has a set of cutting jaws 102, 104 that are activated by moving handle portions 106, 108. Once the pipe is cut to the desired length, it is then coupled to other pieces with a PVC glue/cement material that is commonly supplied in an aluminum container. It is often the case, however, that once the container is opened, the glue/cement finds its way onto the threads of the cap and the cap is then adhesively secured to the container and virtually impossible to open a second time by hand. For this reason, a worker is forced to carry, in addition to the pipe cutting tool 100, a pair of pliers or channel locks, such as the channel locks 200 shown in FIG. 2, to open the glue/cement can. The channel locks 200 have a set of jaws 202 and 204 that are manipulated by handle portions 206 and 208 and are used to grasp and turn the lid of the PVC glue/cement can.

Additionally, some the pipeline pieces have threads and accept counter threads on other pieces for secure coupling of pipeline components. For instance, sprinkler heads generally have threads for easy attachment and removal to the water pipeline. Occasionally, a threaded piece will break and must be extracted. One tool used for extraction is called a “nipple extractor” and is shown in FIG. 3. The nipple extractor 300 is a tool with a T-shaped handle 302 attached to a shaft 304 with a tapered serrated nose portion 306. The serrated nose portion 306 is inserted into a pipe portion until the taper makes solid contact with the portion. The edges of the serrated portion 306 grip the interior of the pipe portion and allow it to be easily unscrewed from its mated piece. The nipple extractor is just one more tool that a pipeline installer/repairer must carry with him. However, it is undesirable to carry, keep track of, and maintain multiple tools when working in the field.

Therefore, a need exists to overcome the problems with the prior art as discussed above.

### SUMMARY OF THE INVENTION

Briefly, in accordance with the present invention, disclosed is a pipe-cutting tool with first and second scissor members pivotally connected to one another where the first scissor member has both a first distal cutting portion with a distal polyvinyl-chloride-pipe cutting blade shaped and of a material for cutting a polyvinyl-chloride pipe and a first proximal grasping portion that has a first outer side shaped to support at least one finger of a user's hand a second inner side having an intermediate portion with a first concave gripping surface having gripping protrusions. The second scissor member has both a second distal cutting portion with a distal concave surface opposing the cutting blade and shaped to support a PVC-pipe therein between ½ inch and 2 inches in diameter and a second proximal grasping portion that has a first outer side shaped to support a palm of a user's hand and a second inner side having an intermediate portion with a second concave gripping surface having gripping protrusions, the second concave gripping surface disposed directly opposite the first concave gripping surface and, together, operable to securely grip a lid therebetween when the first and second proximal grasping portions are moved towards one another.

In accordance with another feature, the distal concave surface of the second distal cutting portion includes an elongated slot shaped to receive the cutting blade therein and is sufficiently deep to permit the cutting blade to travel at least as far as an innermost point of the concave surface.

In accordance with yet another feature, an embodiment of the present invention includes a pair of cutting jaws shaped and of a material operable to grasp and cut a polyvinyl-chloride pipe, a movable handle coupled to the cutting jaws and operable to manipulate the cutting jaws, and a pair of lid-grasping areas each one disposed on one of a pair of opposing inside surfaces of the movable handle, the lid grasping areas operable to securely grip a lid when closing pressure is applied to the movable handle.

In accordance with a further feature of the present invention, at least one of the pair of lid-grasping areas includes a high-friction surface.

In accordance with another feature of the present invention, the handle includes a nipple extractor holding area coupled to the handle.

In accordance with yet one more feature of the present invention, the handle includes a bottle opener.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a side elevational view of a prior art PVC cutting tool;

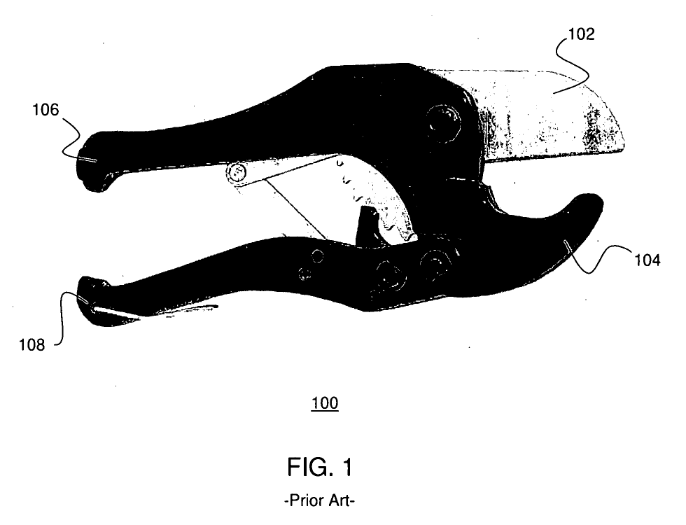

FIG. 2 is a side elevational view of a prior art channel lock tool;

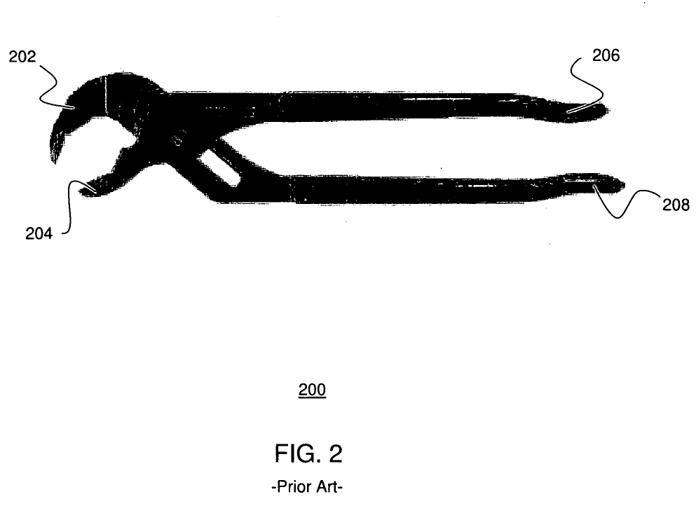

FIG. 3 is a side elevational view of a prior art extraction tool;

FIG. 4 is a side elevational view of a cutting tool with gripping areas disposed in a handle thereof in accordance with an exemplary embodiment of the present invention;

FIG. 5 is a side elevational view of the cutting tool of FIG. 4 with extractor storage and bottle opening features in accordance with an exemplary embodiment of the present invention; and

FIG. 6 is a perspective view of the prior art cutting tool of FIG. 1 illustrating an elongated slot in a lower jaw thereof.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The present invention provides a novel and efficient multi-use irrigation tool useful for replacing and repairing sprinkler and irrigation systems. The inventive tool provides a cutting portion, a gripping handle portion that can be used to easily and safely open PVC cement jars, as well as a nipple extraction tool and, in some embodiments, a beverage opener.

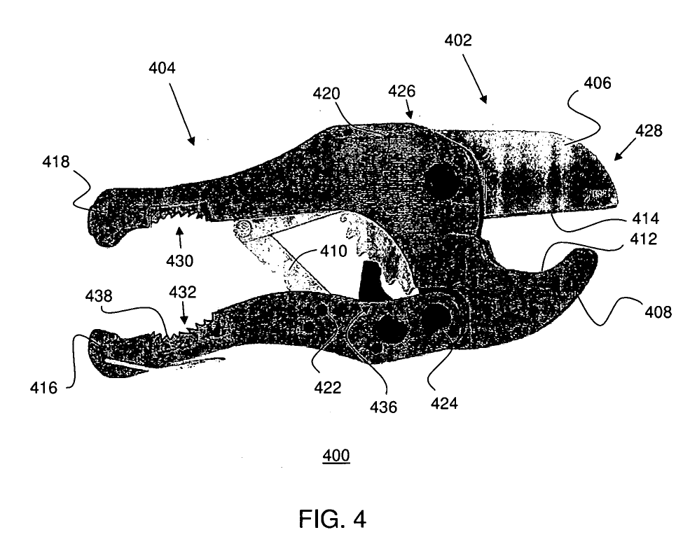

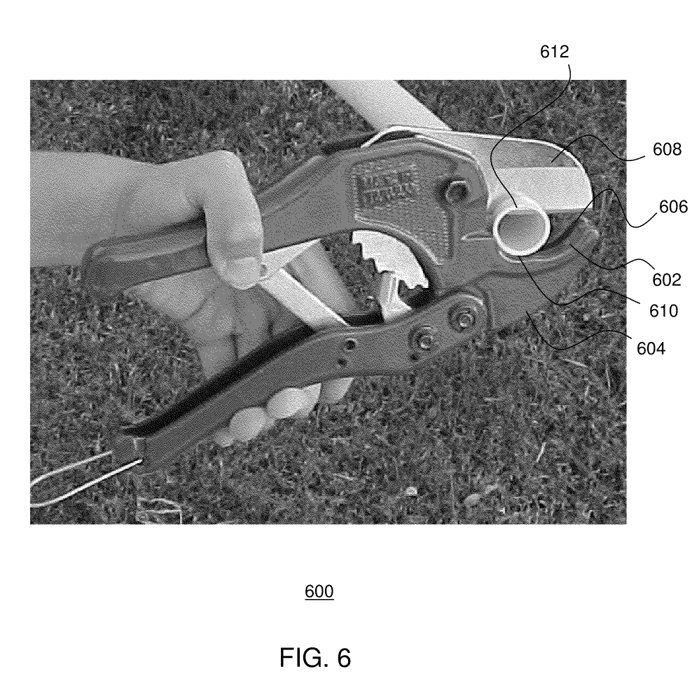

FIG. 4 shows an exemplary embodiment of the present invention, which can be described as having two main portions, a jaw portion 402 and a handle portion 404. The jaw portion 402 includes an upper jaw 406 and a corresponding opposing lower jaw 408. The upper jaw 406, in this embodiment, is a blade that is useful for slicing through various materials, namely, but not limited to PVC material. The lower jaw 408, opposite the upper jaw 406, in the particular embodiment shown, has a curved shape with an inner concaved edge 412 shaped to accept a cutting edge 414 of the blade 406. The curved lower jaw 408 is particularly well suited for holding a pipe, which also has a curved shape, during a cutting process. In one embodiment, the curved lower jaw 408 is shaped to provide the tool 400 with a capacity to cut a pipe between about ½″ to about 2″ in diameter. Further details of the lower jaw 408 are shown in FIG. 6, which shows another view of a prior-art cutting tool 600 to which the inventive features of the present invention can be added. The view of FIG. 6 shows the prior-art cutting tool 600 being used to cut a PVC pipe 612. This view shows the concave surface 602 in the lower jaw 604 having an elongated slot 606 shaped to receive the cutting blade 608 therein and being sufficiently deep to permit the cutting blade 608 to travel at least as far as an innermost point 610 of the concave surface 602 of the lower jaw. The slot 606, therefore, allows the cutting blade 608 to slice entirely through the pipe 612 that the jaws are supporting while cutting takes place.

Referring now back to FIG. 4, attached to and operable to manipulate the jaws 406 and 408 relative to each other is the elongated handle portion 404. The handle portion 404 includes a lower handle element 416 and an upper handle element 418. The lower handle element 416 is coupled to the upper jaw 406 by a connecting rod 410. The connecting rod 410, in turn, is attached to a proximal end 426 of the upper cutting jaw 406, the proximal end 426 being opposite the distal end 428 where cutting takes place. The upper handle element 418 is coupled to or integral with the lower jaw 408.

Coupling of the various parts and movement of the cutting tool 400 is achieved through the provision of several pivot points 420, 422, 424. More specifically, the upper cutting jaw 406 is coupled to the cutting tool 400 by a first pivot point 420. Pivoting action of the upper cutting jaw 406 is provided by the connecting rod 410, which is itself connected to the lower handle element 416 at a second pivot point 422. The lower handle element 416 is connected to the lower jaw 408 by a third pivot point 424. When the lower handle element 416 and upper handle element 418 are moved in a direction toward each other, the connecting rod 410 applies an upward force to the proximal end 426 of the upper cutting jaw 406. Because the first pivot 420 is located between the distal end 428 and proximal end 426 of the upper cutting jaw 406, the upward force applied by the connecting rod 410 to the proximal end 426 of the upper cutting jaw 406 forces the distal end 428 in a direction toward the lower jaw 408. Conversely, a separation of the handle elements 416 and 418 causes the connecting rod 410 to apply a pulling pressure to the proximal end 426 of the upper cutting jaw 406, resulting in the distal end 428 moving away from the lower jaw 408.

In one embodiment, the cutting tool 400 has a ratcheting feature 436 to reduce user fatigue. In an exemplary embodiment, the handle is made of die cast/aluminum composite materials and one or more of the internal parts and pivots are of stainless steel.

FIG. 4 also shows an opposing set of gripping areas 430 and 432 located within the handle elements 416 and 418 making up the handle section 404. The gripping areas 430 and 432, in one embodiment, are recessed areas in the handle section 404. Each area 430 and 432 has protrusions 438, such as a set of serrated teeth or other frictional surface that is well suited for gripping the lid of a can of PVC glue/cement or other objects. When the handle elements 416 and 418 are compressed toward each other, the handle elements 416 and 418 act as lever arms and allow a significant squeezing force to be applied to the gripping areas 430 and 432. By twisting either the glue/cement can or the cutting tool 400 while this squeezing force is applied, the lid can easily and quickly be removed from the can. Advantageously, the novel serrated areas 430 and 432 obviate the need for a worker to carry a pair of pliers 200 with him in the field. Of course, the serrated teeth/grooves shown in FIG. 4 are merely one example of a surface capable of applying a frictional force to lid. Other surfaces and materials that are suitable for opening a PVC glue/cement lid are within the scope of the present invention.

The details and interworking components of the cutting tool 400 have been described and shown in detail in FIG. 4. These details are merely to provide an understanding of an exemplary cutting tool and the present invention is in no way limited to the particular device shown and described above. Therefore, other embodiments of cutting tools having gripping areas within the handle are within the scope of the instant disclosure. For instance, the cutting tool 400 can be merely a scissor-type device with first and second scissor members pivotally connected to one another. The first scissor member 416, 406 can be defined as including the distal cutting portion 428 with the distal polyvinyl-chloride-pipe cutting blade 406 shaped and of a material for cutting a polyvinyl-chloride-pipe and a first proximal grasping portion 416 having a first outer side shaped to support the fingers of a user's hand and a second inner side having an intermediate portion 432 with a first concave gripping surface having gripping protrusions. The second scissor member 418, 408 has a second distal cutting portion 408 with a distal concave surface 412 opposing the cutting blade and shaped to support a PVC-pipe therein between ½ inch and 2 inches in diameter and a second proximal grasping portion 418 having a first outer side shaped to support a palm of a user's hand and a second inner side 430 having an intermediate portion with a second concave gripping surface having gripping protrusions 438, the second concave gripping surface 430 disposed directly opposite the first concave gripping surface 432 and, together, operable to securely grip a lid therebetween when the first and second proximal grasping portions are moved towards one another.

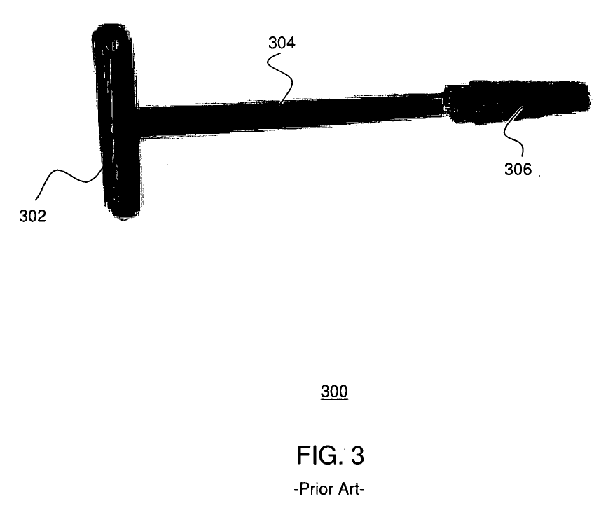

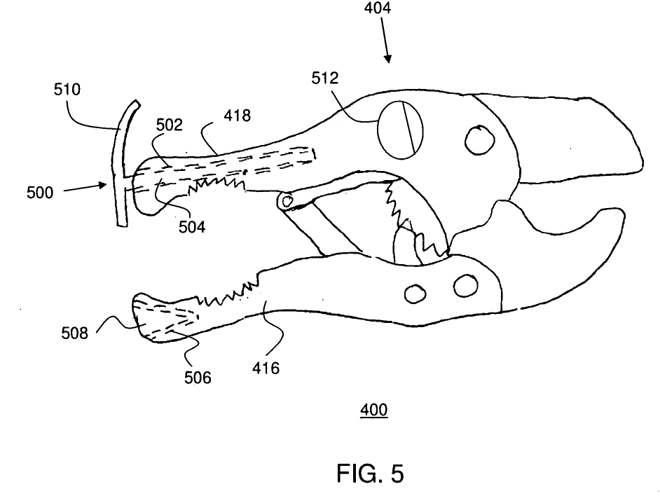

FIG. 5 shows additional novel features present in other embodiments of the present invention. Within and starting at one end of the upper handle element 418 is nipple extractor tool holding chamber 502. The chamber 502 is able to accept and securely hold the shaft 504 of a nipple extractor tool 500, similar to the extractor 300 shown in FIG. 3. In other embodiments, the upper handle element 418 does not have the chamber 502, but instead is provided with a clasping mechanism that mechanically grasps the extractor tool 500 and securely couples it to the cutting tool 400. One such clasping mechanism can be one or a set of C-clamps. In yet another embodiment, the upper handle element 418 is provided with a magnet that magnetically couples the extractor tool handle 504 to the cutting tool 400.

Because, as shown in FIG. 3, the end 306 of the nipple extractor 300 is large, and because the handle portion 418 is of a definite length, in one embodiment of the present invention, the end 306 of the nipple extractor 300 is removed and stored in a location different from the storage location 502 of the rest of the nipple extractor handle 504. In one embodiment, the lower handle element 416 defines a second chamber 506 where the end 508 of the nipple extractor 500 is shown stored within. When needed, the end 508 of the nipple extractor 500 can be removed from chamber 506 and the handle 504 can easily be removed from the other chamber 502 so that the nipple extractor 500 can be assembled and used as needed. In other embodiments, the handle element 416 does not have the chamber 506, but, instead, is provided with a clasping mechanism that mechanically grasps the extractor tool end 508 and securely couples it to the cutting tool 400. In yet another embodiment, the lower handle element 416 is provided with a magnet that magnetically couples the extractor tool end 508 to the cutting tool 400.

As an added feature, one end 510 of the nipple extractor handle 504 has a curved shape. The curved shape is advantageous as it provides a convenient mechanism for hanging the tool on a pegboard or other storage location.

FIG. 5 shows yet a further feature of the present invention, which is the presence of a bottle opener 512 on the handle portion 404. The bottle opener 512 is of the kind that is useful for removing a metallic cap from a glass bottle, such as a soda or beer bottle. The opener 512 can be a void in one of the handle elements 416, 418 or can be an object coupled to one of the handle elements 416, 418. The shape and function of bottle openers are well known in the art and the details of which will not be described herein. In short, the present invention provides an area on the device that is suitable for opening a glass bottle without damaging the bottle. Use of the beverage opener 512 advantageously allows the user to enjoy a beverage during or after completion of the outdoor project without the user having to obtain a separate tool to open the bottle.

A multi-purpose tool has been disclosed that allows convenient and efficient replacement and repair of sprinkler and irrigation systems. The tool provides threads to the inside surface of the handle of the pvc/pipe cutter, thereby allowing the user to open standard cement jars, often used in the replacement and repair process for irrigation systems. The inventive tool also houses a nipple extractor and beverage opener.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A cutting tool comprising:
a pair of cutting jaws shaped and of a material operable to grasp and cut a polyvinyl-chloride pipe;
a movable handle coupled to the cutting jaws and operable to manipulate the cutting jaws; and
a pair of lid-grasping areas each one disposed on one of a pair of opposing inside surfaces of the movable handle, the lid-grasping areas operable to securely grip a lid when closing pressure is applied to the movable handle.

2. The cutting tool according to claim 1, wherein:
at least one of the pair of lid-grasping areas includes a high-friction surface.

3. The cutting tool according to claim 2, wherein:
the high-friction surface includes serrated teeth.

4. The cutting tool according to claim 1, further comprising:
a nipple extractor holding area coupled to the handle.

5. The cutting tool according to claim 4, wherein:
the nipple extractor holding area is defined by and within the handle.

6. The cutting tool according to claim 1, further comprising:
a bottle opener coupled to the handle.

7. The cutting tool according to claim 4, wherein:
the bottle opener is at least partially defined within the handle.

8. The cutting tool according to claim 4, wherein:
the bottle opener is provided on the handle.

9. A cutting tool comprising:
a first jaw having a concave surface shaped to support a PVC-pipe therein between ½ inch and 2 inches in diameter;
a second jaw opposing the first jaw and including a polyvinyl-chloride-pipe cutting blade;
a first handle portion mechanically coupled to the first jaw and having a first inside surface;
a second handle portion mechanically coupled to the second jaw and operable to move the second jaw in a direction toward the first jaw, the second handle portion opposing the first handle portion and having a second inside surface facing the first inside surface of the first handle portion;
a first concaved lid-gripping section disposed on the first inside surface of the first handle portion; and
a second concaved lid-gripping section disposed on the second inside surface of the second handle portion opposing the first gripping section.

10. The cutting tool according to claim 9, wherein:
at least one of the first gripping section and the second gripping section includes protrusions.

11. The cutting tool according to claim 9, further comprising:
a nipple extractor holding area coupled to at least one of the first handle portion and the second handle portion.

12. The cutting tool according to claim 11, further comprising:
a nipple extractor tool removably coupled to at least one of the first handle portion and the second handle portion, the nipple extractor tool having a curved handle portion operable for hanging the cutting tool on a fixed structure.

13. The cutting tool according to claim 9, further comprising:
a bottle opener coupled to at least one of the first handle portion and the second handle portion.

14. The cutting tool according to claim 13, wherein:
the bottle opener is at least partially defined within at least one of the first handle portion and the second handle portion.

15. The cutting tool according to claim 13, wherein:
the bottle opener is provided on at least one of the first handle portion and the second handle portion.

16. The cutting tool according to claim 9, wherein the first jaw comprises:
an elongated slot shaped to receive the cutting blade therein and is sufficiently deep to permit the cutting blade to travel at least as far as an innermost point of the concave surface.

17. A pipe-cutting tool comprising:
first and second scissor members pivotally connected to one another;
the first scissor member having:
a first distal cutting portion with a distal polyvinyl-chloride-pipe cutting blade shaped and of a material for cutting a polyvinyl-chloride pipe; and
a first proximal grasping portion having:
a first outer side shaped to support at least one finger of a user's hand; and
a second inner side having an intermediate portion with a first concave gripping surface having gripping protrusions; and
the second scissor member having:
a second distal cutting portion with a distal concave surface opposing the cutting blade and shaped to support a PVC-pipe therein between ½ inch and 2 inches in diameter; and
a second proximal grasping portion having:
a first outer side shaped to support a palm of a user's hand; and
a second inner side having an intermediate portion with a second concave gripping surface having gripping protrusions, the second concave gripping surface disposed directly opposite the first concave gripping surface and, together, operable to securely grip a lid therebetween when the first and second proximal grasping portions are moved towards one another.

18. The cutting tool according to claim 17, wherein the distal concave surface of the second distal cutting portion comprises:
an elongated slot shaped to receive the cutting blade therein and is sufficiently deep to permit the cutting blade to travel at least as far as an innermost point of the concave surface.

19. The cutting tool according to claim 17, wherein:
at least one of the gripping protrusions form a frictional surface.

20. The cutting tool according to claim 19, wherein:
the frictional surface includes serrated teeth.
